(19) United States
(12) Patent Application Publication
(10) Pub. No.: US 2017/0123777 A1
(43) Pub. Date: May 4, 2017

(54) DEPLOYING APPLICATIONS ON APPLICATION PLATFORMS

(71) Applicant: HEWLETT PACKARD ENTERPRISE DEVELOPMENT LP, Houston, TX (US)

(72) Inventors: Shruthi Mittal, Bangalore (IN); Arun Pai, Bangalore (IN)

(21) Appl. No.: 15/095,230

(22) Filed: Apr. 11, 2016

(30) Foreign Application Priority Data
Oct. 28, 2015 (IN) 5821/CHE/2015

(51) Int. Cl. G06F 9/445

(52) U.S. Cl. CPC G06F 8/60

(57) ABSTRACT

Examples of techniques to deploy an application on an application platform are described. In an example, an input application design, that defines dependencies for the application for the components of the application platform based on capability attributes and characteristic attributes, is received. The capability attributes provide deployment requirements of the application and the characteristic attributes provide specifications of the deployment requirements. A candidate design comprising at least one of the components of the application platform is identified based on the attributes. The candidate design is a configuration of the application platform to deploy the application. A service design, that specifies operational requirements for deploying the application, is generated based on the candidate design.

### BACKGROUND

Generally, application developers, software testers, and quality assurance personnel deploy applications on different application platforms for various purposes. For example, to ensure conformance with predefined performance requirements, an application developer may continuously test an application along its development lifecycle, by deploying the application on application platforms. For the purposes of software testing and quality assurance too, the application may be deployed on application platforms, prior to or after deployment of the application in a production environment.

To deploy an application on an application platform, various configurations of the application platform may be examined and a configuration having components to support the application is identified.

### BRIEF DESCRIPTION OF DRAWINGS

The following detailed description references the drawings, wherein:

FIG. 1 schematically illustrates an example network environment implemented for deploying an application on application platforms, consistent with disclosed implementations;

FIG. 2A and 2B illustrate example application deployment systems, consistent with disclosed implementations; and

FIGS. 3 illustrates an example method for creating a service design to deploy the application on an application platform, consistent with disclosed implementations;

FIG. 4 illustrates an example method to identify a candidate design for creating the service design to deploy the application, consistent with disclosed implementations:

FIG. 5 illustrates an example network environment for deploying the application on application platforms, consistent with disclosed implementations.

### DETAILED DESCRIPTION

The following detailed description refers to the accompanying drawings. Wherever possible, the same reference numbers are used in the drawings and the following description to refer to the same or similar parts. While several examples are described in this document, modifications, adaptations, and other implementations are possible. Accordingly, the following detailed description does not limit the disclosed examples. Instead, the proper scope of the disclosed examples may be defined by the appended claims.

Generally, an application platform comprises numerous software and hardware components, such as web servers, and application servers of various types. The application platform may have various configurations to deploy an application, each configuration comprising different combinations of the components of the application platform. Depending on deployment requirements of the application, one or more configurations of an application platform, also referred to as a design of the application platform, may be implemented to deploy the application. For example, for an application that supports four different types of database servers and two different types of web servers of the application platform, there may exist eight possible designs for deploying the application.

Accordingly, to deploy the application, a design having components in conformance with the deployment requirements of the application is identified, and a service design specifying operational requirements for deploying the application is created.

Generally, to deploy the application in accordance with a design of the application platform, a service design is created by defining the components that may support the application. Each of the components may have further deployment requirements. For example, a design may comprise a virtual web server as a component wherein the web server is to be installed on a computer server having a predefined memory and processor configuration for the web server to operate. Thus, creation of the service design involves identification of additional deployment requirements associated with each of the components as well.

Generally, numerous designs each having several components may exist. In identifying designs that may conform to the deployment requirements of the application, the additional deployment requirements of the significantly high number of components may often be overlooked during creation of the service designs.

The present subject matter describes systems and methods relating to deployment of applications on application platforms. In an example, the systems and methods provide for identification of a design of the application platform, herein referred to as a candidate design, that may be implemented to deploy the application, and creation of a service design that takes into consideration additional deployment requirements of the components of the design of the application platform.

In an example implementation, an input application design is created for an application to be deployed. The input application design defines dependencies for the application for one or more components of the application platform based on capability attributes and characteristic attributes corresponding to the application. The capability attribute may be considered so as to provide deployment requirements of the application while the characteristic attribute provides specifications of the capability attribute corresponding to the components of the application platform. Candidate designs, corresponding to configurations of the application platform that may support the application, are identified based on the capability attributes and characteristic attributes of the application. Each of the candidate designs comprises one or more components of the application platform, such that the deployment requirements for implementing the candidate designs are satisfied by the application platform. A service design that specifies operational requirements for deploying the application on the application platform based on any of the candidate designs may then be created.

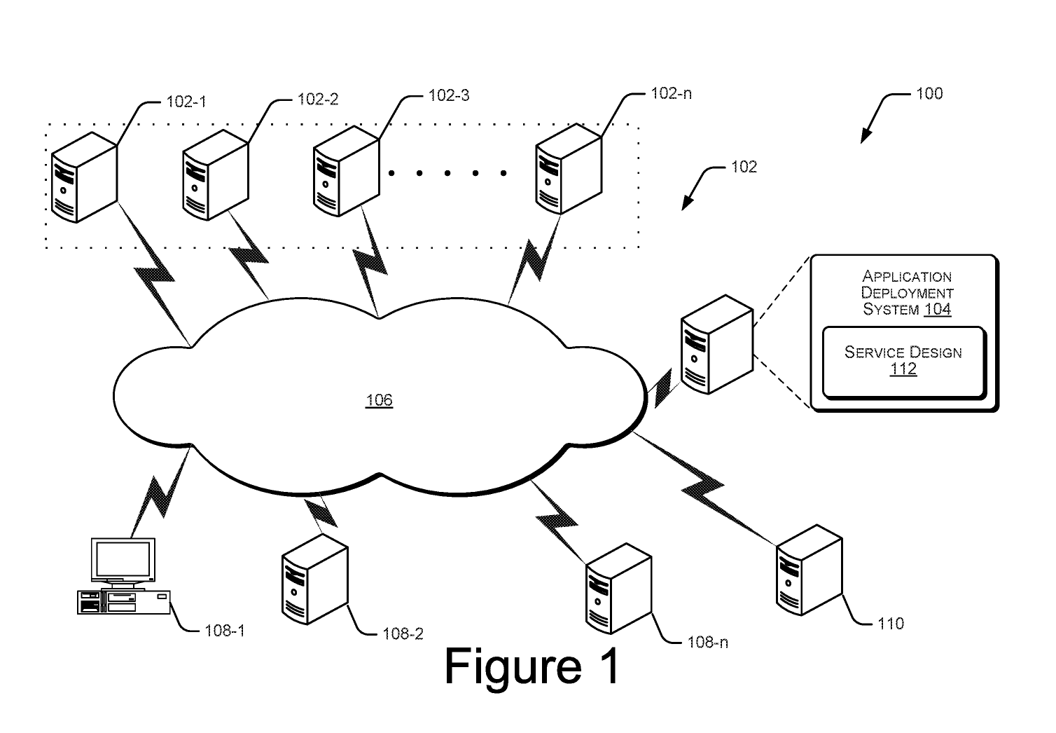

FIG. 1 schematically illustrates an example network environment 100 implemented for deploying an application on an application platform 102, consistent with disclosed implementations.

In an example implementation, the application platform 102 may comprise a group of computing devices 102-1, 102-2, 102-3, . . . 102-n that interact with each other to support functioning of an application that may be deployed on the application platform 102. The computing devices 102-1, 102-2, 102-3, . . . 102-n may be implemented in various ways. For example, each of the computing devices 102-1, 102-2, 102-3, . . . 102-n may be a special purpose computer, a server, a mainframe computer, and/or any other type of computing system.

In an example, each of the computing devices 102-1, 102-2, 102-3, . . . 102-n may include components of the application platform 102, also referred to as platform components, or, simply components. The components perform predefined functionalities that support a deployed application. For instance, each of the components may perform functions of a web server, a database server, an application server or any other functionality that supports the deployed application. It may be noted that a computing device 102-1, 102-2, 102-3, . . . or 102-n may include more than one components. For instance, the computing device 102-n may be a computer server implementing a web server and a database server. In other words, the computing device 102-n may be a hardware or infrastructure component that may be implemented to perform more than one functionalities, such as that of a web server and database server, in the present example.

An application deployment system 104 may be implemented to deploy an application on the application platform 102. The application deployment system 104, may be implemented in various ways, such as a server, a mainframe computer, a laptop, a desktop computer, a tablet, a special purpose computer, and/or any other type of computing system. While for the ease of depiction, the figure depicts the application deployment system 104 to be coupled to one application platform 102, it will be understood that the application deployment system 104 may be coupled to multiple other application platforms each comprising various computing devices. The application deployment system 104 may deploy the application on one or more of the multiple other application platforms in a manner similar to that explained in context of the application platform 102.

In the example implementation illustrated in FIG. 1, the application deployment system 104 communicates with the computing devices 102-1, 102-2, 102-3, . . . 102-n of the application platform 102 through a communication network 106 for various purposes including, deployment of an application. Also, the computing devices 102-1, 102-2, 102-3, . . . 102-n may interact with each other through the communication network 106 to support various operations of a deployed application.

The communication network 106 may be implemented as a wireless network or a wired network, or a combination thereof. The communication network 106 can be an individual network or a collection of many such individual networks, interconnected with each other and functioning as a single large network, e.g., the Internet or an intranet. The communication network 106 can be implemented as one of the different types of networks, such as local area network (LAN), wide area network (WAN), and such. The communication network 106 may either be a dedicated network or a shared network, which represents an association of the different types of networks that use a variety of protocols, for example, Hypertext Transfer Protocol (HTTP), Transmission Control Protocol/Internet Protocol (TCP/IP) etc., to communicate with each other. The communication network 106 may also include individual networks, such as, but are not limited to, GSM network, UMTS network, LTE network, PCS network, TDMA network, COMA network, NGN, PSTN, and ISDN. The computing devices 102-1, 102-2, 102-3, . . . 102-n and the application deployment system 104 work on communication protocols that are compatible with the communication network 106 to which they are coupled.

While FIG. 1 shows the computing devices 102-1, 102-2, 102-3, . . . 102-n and the application deployment system 104 communicatively coupled through network 102, the computing devices 102-1, 102-2, 102-3, . . . 102-n may be directly coupled to the application deployment system 104. Similarly, one or more of the computing devices 102-1, 102-2, 102-3, . . . 102-n of the application platform 102 may also be directly coupled to each other.

In accordance with one example implementation of the present subject matter, the application to be deployed on the application platform 102 may be developed by developers using one or more of user computing devices 108-1, 108-2, . . . 108-n, each coupled to the communication network 106. The user computing devices 108-1, 108-2, . . . 108-n, may also be implemented in a variety of ways alike the application deployment system 104 and the computing devices 102-1, 102-2, 102-3, . . . 102-n. In some example implementations, a user computing device 108-1, 108-2, . . . or 108-n, may also belong to a user, such as a software tester who may wish to deploy an application residing on the user computing device 108-1, 108-2, . . . or 108-n, on the application platform 102, for example, to test the application.

In an example implementation, an input application design is created for the application to be deployed. The input application design defines dependencies for the application with respect to one or more components of the application platforms. In one example, the dependencies are defined based on capability attributes and characteristic attributes wherein the capability attributes provide deployment requirements of the application while the characteristic attributes provide specifications of the capability attributes corresponding to the one or more components of the application platform.

To illustrate with an example, the capability attributes of an application, may be defined as a web server, an application server and a database server. Accordingly, the deployment requirements for deploying the application are components that possess capabilities of a web server, an application server and a database server, or, in other words, components that perform functionalities of a web server, an application server and a database server.

Further, the input application design may also define one or more characteristic attributes corresponding to each of the capability attributes to provide specifications of each of the capability attributes. Referring to the above example for explanation, for the capability attribute ‘application server’, the characteristic attributes may specify that the ‘application server’ may be any application server, authored by a provider, which may generally used for hosting on or more applications. As would be understood, such application server may be identifiable by their names which may uniquely identify one application server from another. For the purposes of the present description, applications server names may be AppServer 1, AppServer 2, and so on. In a similar manner, various other nomenclatures have been used to uniquely identify the names of the different components.

Continuing with the present explanation, for the capability attribute ‘database server’, the characteristic attributes may be dbServer 1 or dbServer 2, for example. The input application design thus captures the deployment requirements and their corresponding specifications for the application.

The input application design of the application may be provided to the application deployment system 104 by one or more of the user computing devices 108-1, 108-2, . . . 108-n to deploy the application on the application platform 102. In some examples, the input application design may be sent to the application deployment system 104 along with or may follow a request to deploy the application, while, in some other examples, the input application design may itself be indicative of the request to deploy the application to the application deployment system 104.

As explained previously, for any given application platform, numerous possible designs, each comprising different components, may exist. In an example implementation, the numerous designs corresponding to application platform 102 may be stored in a repository 110. Based on the input application design received, the application deployment system 104 identifies one or more candidate designs from amongst the designs stored in the repository 110. Each of the candidate design is a configuration of the application platform 102 comprising components that are capable of supporting the application and are identified based on the capability attributes and characteristic attributes of the application component.

For instance, for an application that has a capability attributes as ‘database server’ and ‘application server’ with the characteristic attributes as ‘dbServer 1 and ‘AppServer 1’, respectively, the designs of the application platform 102 comprising components that conform with the capability and characteristic attributes, wherein the deployment requirement to implement the design may be satisfied by the application platform, are identified as candidate designs. The process of identifying the candidate designs has been elaborated subsequently.

Based on a candidate design, the application deployment system 104 creates a service design 112. The service design 112 specifies operational requirements for deploying the application on the application platform 102. For example, a service design 112 to deploy an application having a capability attributes as ‘database server’ and characteristic attributes as ‘Oracle server’ may specify operational requirements, such as processor and memory requirements for a component of the candidate design that is to deploy the application. The application is then deployed on the application platform using the service design 112.

As opposed to the generally known techniques of deploying applications, the methods implemented by the application deployment system 104 as described herein are independent of the skill of the developers to provide various operational requirements for deploying an application. The developers' task is simplified to defining the dependencies for an application for one or more application platforms based on capability attributes and characteristic attributes, relieving them of the cumbersome and error-prone task of identifying the candidate designs and generating service designs.

It will be understood that more than one service designs may be created depending on the number of candidate designs identified. It will also be understood that, while, in the foregoing description, the creation of the service design 112 is explained in context of example applications having a few deployment requirements, an application stack to be deployed may have significantly high number of application components each having several deployment requirements. As such, the input application design is created to capture capability attributes and characteristic attributes for each of the application components. Accordingly, the candidate design is identified such that it comprises components to support all the application components and further the service design provides operational requirements for deploying all the application components.

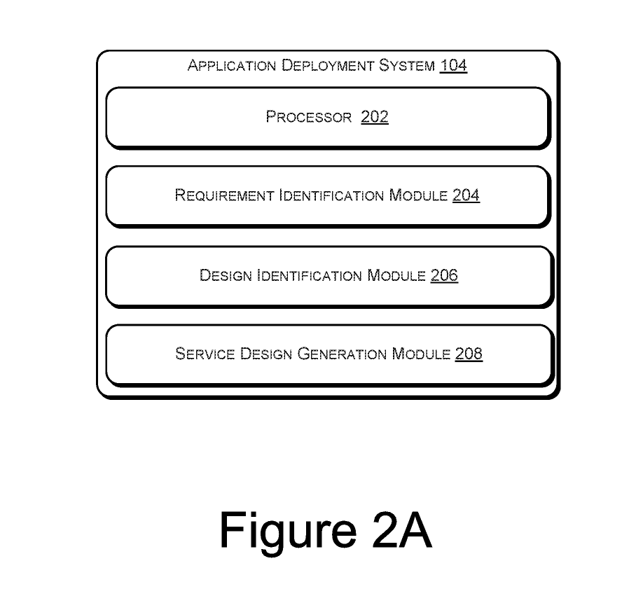

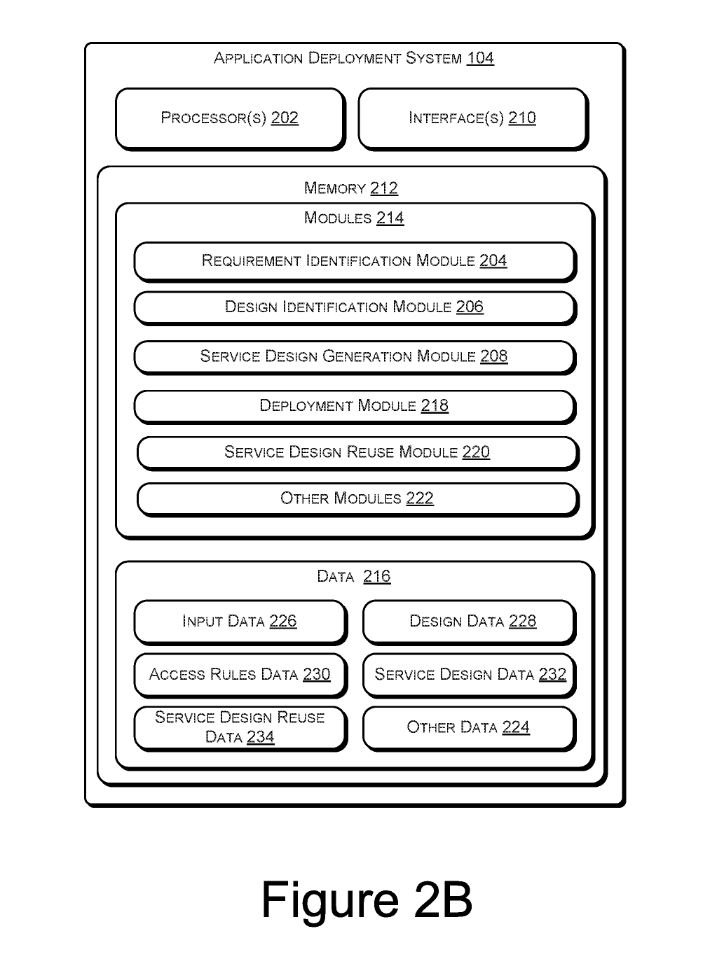

Further details relating to implementation and working of the application deployment system 104 are described in reference to FIGS. 2A and 2B that illustrate example application deployment systems, consistent with disclosed implementations.

Referring to the example implementation illustrated in FIG. 2A, the application deployment system 104 comprises a processor 202, a requirement identification module 204, a design identification module 206 and a service design generation module 208, each coupled to the processor 202.

The processor 202 may be implemented as one or more microprocessors, microcomputers, microcontrollers, digital signal processors, central processing units, state machines, logic circuitries, and/or any devices that manipulate signals based on operational instructions. Among other capabilities, the processor(s) 202 is to fetch and execute computer-readable instructions stored in the modules. The modules include routines, programs, objects, components, data structures, and the like, which perform particular tasks or implement particular abstract data types

In operation, the requirement identification module 204 may receive the input application design of the application to be deployed on the application platform 102. The design identification module 206 identifies one or more candidate designs to deploy the application, based on the capability attributes and characteristic attributes of the application. As explained previously, a candidate design is a configuration of the application platform 102 that supports the application, wherein components of the application platform 102 satisfy deployment requirements for implementing the candidate design. In one example, the candidate design could be specified by way of an extensible Markup Language (XML) file or a Java Script Object Notification (JSON) file. Thereafter, the service design generation module 208 creates the service design 112 based on one of the identified candidate designs. The service design 112 provides operational requirements to implement the candidate design for deploying the application.

For an application having multiple application components, the service design may be created taking into account the capability and characteristic attribute of each such application components as explained previously.

Reference is now made to FIG. 2B that illustrates another example implementation of the application deployment system 104, consistent with disclosed implementations. In accordance with the example implementation illustrated in FIG. 2B, the application deployment system 104 comprises interface(s) 210 and memory 212 coupled to the processor 202.

The interfaces 210 may include a variety of software and hardware interfaces that allow the application deployment system 104 to interact with the computing devices 102-1, 102-2, 102-3, . . . 102-n of the application platform 102 and the user computing devices 108-1, 108-2, . . . 108-n. Further, the interfaces 210 may enable the application deployment system 104 to communicate with the other communication and computing devices, such as the repository 110. The interfaces 210 may facilitate multiple communications within a wide variety of networks and protocol types, including wire networks, for example, LAN, cable, etc., and wireless networks, for example WLAN, cellular, satellite-based network.

The memory 212 may include any computer-readable medium known in the art including, for example, volatile memory (e.g., RAM), and/or non-volatile memory (e.g., EPROM, flash memory, etc.). In accordance with an example implementation illustrated in FIG. 2B, modules 214 and data 216 may reside in the memory 212. Further, in an example, the modules 214 include a deployment module 218, and a service design reuse module 220 in addition to the aforementioned requirement identification module 204, design identification module 206 and service design generation module 208. The modules 214 further include other modules 222 to supplement applications on the application deployment system 104, for example, modules of an operating system.

The data 216 serves, amongst other things, as a repository for storing data that may be fetched, processed, received, or generated by one or more of the modules 214. Among other things, the data 216 may include other data 224. The other data 224 comprise data corresponding to one or more other module(s) 222.

In an implementation, the application deployment system 104, interacts with the user computing devices 108-1, 108-2, . . . 108-n through the interface(s) 210 to receive a request to deploy an application on the application platform 102 with which the application deployment system 104 is coupled. Further, the requirement identification module 204 may receive the input application design of the application. The input application design captures the capability and characteristic attributes of the application and may store the same as input data 226 in the data 216 of application deployment system 104.

The input application design allows identification the configurations of the application platform 102 that may support the application. For identifying such configurations, the design identification module 206 retrieves the various designs corresponding to the application platform 102. In order to make the various designs accessible to the application deployment system 104, the designs may either be stored in the data 216 of application deployment system 104 as design data 228, or, as explained previously, be retrieved from an external repository, such as repository 110. In an example, the repository 110 may be any source code management system or artifact management system.

In some example implementations, the design identification module 206 may retrieve the various designs, based on role-based access rules associated with a user deploying the application. It will understood, that a user deploying the application may have a predefined role, such as that of a developer, tester or quality assurance personnel associated with him. In some cases, the role may be based on the designation of the user in an organization. In an example, identification of the user and his corresponding role may be made based on a ‘user ID’ that requests deployment the application or provides the input application design of the application to be deployed. Predefined role-based access rules associated with the identified user may be retrieved from access rules data 230 stored in the data 216. Alternatively, the role-based access rules may be accessed from an external access rules repository that may be coupled to the application deployment system 104.

From amongst the retrieved designs, candidate designs, each having a configuration capable of hosting the application are identified by the design identification module 206 based on the capability and characteristic attributes of the application. In an example, the design identification module 206 implements an iterative method to identify the candidate designs, as explained below.

The design identification module 206 examines components of each of the designs of the application platform 102. The designs may either be all the various possible designs corresponding to the application platform 102 or a restricted set of designs retrieved based on role-based access rules associated with user deploying the application. The design identification module 206 identifies the eligible designs based on the deployment requirements of the application. An eligible design may be understood as a configuration of the application platform that has components which conform with deployment requirements of the application.

The above is explained in context of an application that has a deployment requirement of a database server and a web server, all configurations of the application platform 102 having a database server and a web server as components may be considered eligible designs. More often than not, although an eligible design satisfies the deployment requirements of the application, it may still not be capable of hosting the application, for example, due to further deployments requirements of a component of the eligible design. To explain this, the previous example, of the application having a deployment requirement of the database server and the web server, may be considered again.

Based on the deployment requirement as defined by the capability and characteristic attributes, in the present example, a design comprising a dbServer 1 and an WebServer 1 may be shortlisted as an eligible design. Further, deployments requirements associated with the components of the eligible design, i.e., the dbServer 1 and the WebServer 1 in the present example, may be determined. Accordingly, it may be identified that the dbServer 1 and the Webserver 1 are to be deployed on a computer server, named as OSServer 1. It should be noted that the nomenclature used is only indicative of the types of platforms that may be utilized. Generally known components may be used without deviating from the scope of the present subject matter.

In case the application platform 102 comprises a OSServer 1 the deployment requirement of the eligible design may be fulfilled, and the eligible design may be considered a candidate design for deploying the application. On the other hand, in case the application platform 102 does not comprise a OSServer 1, i.e., none of the computing devices 102-1, 102-2, 102-3, . . . 102-n of the application platform 102 is a OSServer 1, the eligible design may not be identified as a candidate design.

Accordingly, candidate designs are further filtered from amongst the eligible designs based on the deployment requirements of the components of the eligible designs to ensure that all the deployment requirements of the application and that of the components that are to host the application are complied with. The design identification module 206 may identify one or more candidate design may be identified as the case may be.

In an example implementation, the design identification module 206 may present a preview of each of the identified candidate designs to the user for selection. Based on the candidate design selected, the generation module 208 creates the service design. The service design may be stored as service design data 232 in data 216. The operational requirements for deploying the application provided by the service design are used by the deployment module 218 to deploy the application on the application platform 102.

To elaborate the description of the service design, reference may be made again to the above example. Assuming that the application platform 102 comprises a OSServer 1 that may deploy the dbServer 1 and the WebServer 1, the service design may define respective installation paths for the dbServer 1 and the WebServer 1 to be installed on the OSServer 1. The deployment module 218 deploys the application accordingly to the service design.

While the above example implementations describe the selection of a candidate design, from amongst all the identified candidate designs, for generating the service design to be performed by the user, in some example implementations the selection may be based on predefined rules. For instance, in some example implementations, the identified candidate designs may be presented in an interactive mode that allows a user to select a candidate design for generation of the service design. On the other hand, in some example implementations, the identified candidate designs may be presented in a non-interactive mode wherein the candidate design to generate the service design may be selected based on predefined rules. In an example, the automatic selection of the candidate design to generate the service design may be based on a preference rating associated with each of the identified candidate designs. Accordingly, in situations where more than one candidate designs are identified, various criteria, for example, based on predefined business rules may be applied to chose any one candidate design to deploy the application.

Changes in characteristic attributes that provides specifications of the capability attributes of the application may occur rapidly. For example, for a capability attributes ‘database server’ the characteristic attribute may be changed from ‘dbServer 1’ to dbServer 2. The requirement identification module 204 receives the changes in the attributes and trigger the design identification module 206 to identify candidate designs based on the changed characteristic attributes in accordance with the process described above.

In scenarios where multiple applications having similar deployment requirements are deployed on the application platform, duplication of effort and resources involved in creation of the service designs is generally often observed. For each of the multiple applications, the deployment requirements are determined, corresponding designs to conform to the deployment requirements are identified by taking into consideration additional deployment requirements of the components and multiple service designs are created accordingly. This is computationally extensive.

In accordance with an example implementation, the application deployment system 104 provides for reuse of service designs. For example, a service design created for an application may be used to deploy any other application if the deployment requirements of the other application are same as that of the application for which the service design was created.

Accordingly, in an example implementation, the service design reuse module 220 of the application deployment system 104 creates a checksum for every service design based on a unique identifier associated with the service design. In an example, the checksum for the service designs created by the application deployment system 104 may be stored as service design reuse data 234 in data 216. When a new application for deployment is received, the service design reuse module 220 generates a checksum of the new application based on a unique identifier associated with the new application and revisions and versions of application components of the new application. The checksum of the new application is compared to the checksum of the each of the service designs existing in the application deployment system 104. In case the checksum of the new application matches with the checksum of a service design existing in the application deployment system 104, the service design may be used to deploy the new application. Thus, the present subject matter enables reuse of service designs to reduce computational resources consumed in generating multiple service designs.

In an implementation, the present subject matter also provides for efficient use of computing resources by allowing sharing of a component when the component satisfies multiple deployment requirements. An example application having dependencies for the application platform 102 defined in terms of capability and characteristic attributes may be considered for explanation, wherein ‘web server’, ‘application server’, and ‘database server’ are the capability attributes and WebServer 2, AppServer 3, dbServer 3are the characteristic attribute of the capabilities attributes, respectively,

In the instant example, an eligible design having components in accordance with the above capability and characteristic attributes, for example, a design having a WebServer 2, AppServer 3, and dbServer 3, is selected. Upon examining the components, it may be determined that the component with ‘application server’ capability and ‘AppServer 3’ characteristic is to be hosted on a web server. In other words, the component ‘application server’ may have an additional deployment requirement.

In identifying of candidate designs to satisfy such requirements, the application deployment system 104 enables selection of candidate designs where components may be reused for optimum utilization of computing resources. Accordingly, in the present example, the eligible design includes the WebServer 2 that satisfies the ‘web server’ capability attribute of the application may be used to meet the further deployment requirement of the ‘application server’, thereby allowing the eligible design to be identified as a candidate design. Thus, as apparent, the application deployment system 104 enables identification of components that can be used to fulfill multiple deployment requirements. It may be noted that generally, such additional deployment requirement may be satisfied by incorporating additional components in the designs rather than reusing components to deploy applications.

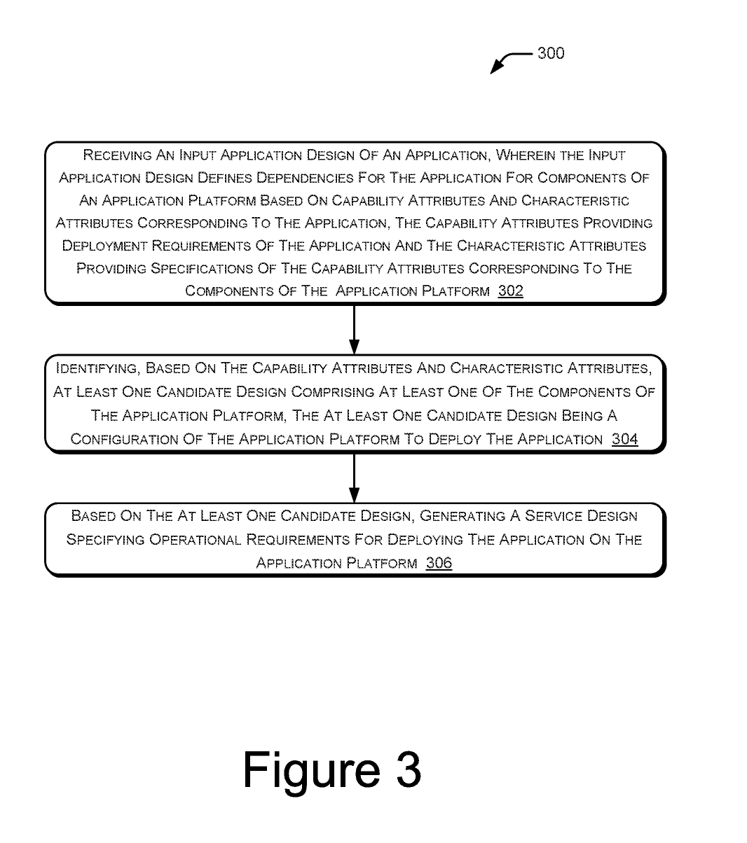

FIG. 3 illustrates an example method 300 for creating a service design to deploy an application on an application platform, consistent with disclosed implementations.

The order in which the method 300 is described is not intended to be construed as a limitation, and any number of the described method blocks can be combined in any order to implement the method 300, or an alternative method. Additionally, individual blocks may be deleted from the method 300 without departing from the spirit and scope of the subject matter described herein. Furthermore, the method 300 can be implemented in any suitable hardware, software, firmware, or combination thereof.

A person skilled in the art will readily recognize that steps of the method 300 can be performed by programmed computing devices. Herein, some examples are also intended to cover program storage devices, for example, digital data storage media, which are machine or computer readable and encode machine-executable or computer-executable programs of instructions, wherein said instructions perform some or all of the steps of the described method. The program storage devices may be, for example, digital memories, magnetic storage media, such as a magnetic disks and magnetic tapes, hard drives, or optically readable digital data storage media. The examples are also intended to cover both communication network and communication system to perform said steps of the example method.

Further, although the method 300 for deploying an application may be implemented in a variety of computing systems working in different network environments, in examples described in FIG. 3, the method 300 is explained in context of the aforementioned application deployment system 104 implemented in the example network environment 100 for ease of understanding,

At block 302, an input application design of an application is received. The received input application design defines dependencies for the application for components of the application platforms based on capability attributes and characteristic attributes corresponding to the application. The capability attribute provides deployment requirements of the application and the characteristic attribute provides specifications of the capability attribute corresponding to the components of the application platforms. As explained previously, in one example, the capability attributes could be ‘web server’ and the characteristic attributes may specify that the ‘web server’ may be an WebServer 1 or an WebServer 2. Similarly, for a capability attribute ‘database server’, the characteristic attributes may be a dbServer 1 or an dbServer 2.

At block 304, at least one candidate design of the application platform, comprising one or more of the components of the application platform, is identified to deploy the application. The identification is based on the capability attributes and the characteristic attributes of the application as identified from the input application design. A candidate design is a configuration of the application platform that may be implemented to support the application. In an example implementation, numerous possible designs of the application platform may be stored in the repository 110 and based on the capability attribute and the characteristic attribute, at least one candidate design that is capable of supporting the application is identified.

As described earlier, the components of the at least one candidate design may also have some deployment requirements and those requirements are satisfied by the components of the application platform. For instance, a component of a candidate design, for example, a web server can have requirements, such as, a predefined CPU and memory configuration or a predefined version of an operating system which may be fulfilled by a computer server, such as computing device 102-n that has the prerequisite hardware and software configuration.

At block 306, based on the at least one candidate design, a service design is generated specifying the operational requirements for deploying the application. In cases where more than one candidate designs are identified, a candidate design for generating the service design is selected based on user input or predefined rules. Similarly, more than one service designs may also be created depending on the number of identified candidate designs selected for generation of the service design.

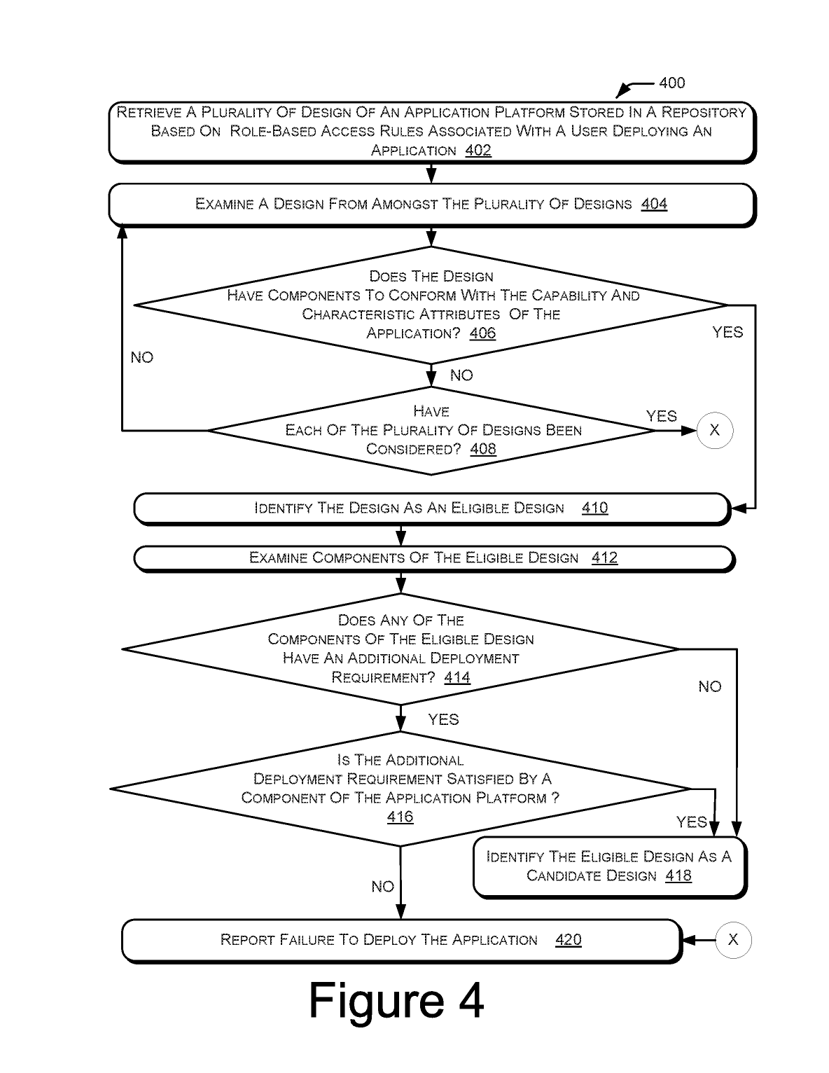

FIG. 4 illustrates an example method 400 to identify a candidate design for creating the service design to deploy the application, consistent with disclosed implementations. Method 400 can also be implemented in various computing system alike method 300 but is explained here in context of the application deployment system 104 for ease of understanding. Method 400 may be considered an example method for carrying out the abovementioned block 304 of identifying the at least one candidate design.

At block 402, a plurality of designs of the application platform is retrieved from a repository, such as design data 228 and the repository 110, based on a request to deploy an application on the application deployment system 104 from a user. The plurality of designs may be retrieved based on the role-based access rules associated with a user. For example, when a user provides an input application design of an application to be deployed to the application deployment system 104, a role associated with the user may be determined based on the login credentials used by the user. Once the role is identified, predefined role-based access rules associated with the user may be retrieved. In an example, the role-based access rules may restrict the user from accessing some of the designs. Thus, the designs that are accessible to a user based on his role may be retrieved.

All the retrieved designs are examined for identification of the candidate designs. Accordingly, at block 404, a design, from amongst the plurality of retrieved designs is examined. At block 406, a determination is made whether the design being examined has components to conform with the capability and characteristic attributes of the application. If the determination is ‘yes’ then the process proceeds to block 410 where the design is identified as the eligible design. On the other hand, if the determination is ‘no’, i.e., the components of the design do not conform to capability and characteristic attributes of the application, the process proceeds to block 408.

At block 408, it is determined if each of the plurality of design that were retrieved have been considered for examining their components in the previous step. If the outcome of block 408 is ‘yes’, i.e., each of the plurality of designs have been considered and there are no designs left, then the process proceeds to block 420, and due to unavailability of designs, at block 420, a failure to deploy the application is reported. If the outcome of block 408 is ‘no’, i.e., there are more designs that need to be considered, the process proceeds to block 404 where the next design is taken-up for examination. The loop of the process from the ‘no’ branch of block 408 to block 404 continues till all the retrieved designs are exhausted.

Once the ‘yes’ branch of block 406 proceeds to block 410 and the design is identified as the eligible design, at block 412, the components of the eligible design are examined. At block 414, it is determined whether any of the components of the eligible design have an additional deployment requirement. If the determination is ‘no’ the process proceeds to block 418 and the eligible design is identified as a candidate design. On the contrary, if the determination is ‘yes’, i.e., a component of the eligible design has an additional deployment requirement, the process proceeds to block 416,

Upon realizing that a components of the eligible design has an additional deployment requirement, at block 416, it is further ascertained if the additional deployment requirement may be satisfied by a component of the application platform. If the determination is ‘yes’ it indicates that the application platform has components that conform to the additional deployment requirements for implementing the design to deploy the application. Accordingly, at block 418, the eligible design is identified as a candidate design. However, if the determination at block 416 is ‘no’, the application platform is concluded as being incapable of addressing the additional deployment requirements for implementing the design and, thus, as indicated at block 420, a failure to deploy the application is reported.

The example method 400 of identifying the candidate designs takes into account each of the various designs of the application platform on a component-by-component basis to determine additional deployment requirements of the components of the design of the application platform. Thus, the process of identification of a design of the application platform that may be implemented to deploy the application is performed thoroughly and efficiently.

Further to allow optimization of computing resources, candidate designs that incorporate computing devices 102-1, 102-2, 102-3, . . . 102-n that have multiple components to fulfil more than one deployment requirement of the application simultaneously may be selected.

For the ease of explanation, an example application may be considered. The capability and characteristic attributes of the example application may be ‘web server’, ‘application server’, and ‘database server’ and the capability attributes may be WebServer 3, AppServer 3, dbServer 4, respectively. The dbServer 4 as well as the WebServer 3 may have further deployment requirement of a OSServer 1.

Accordingly, in one example implementation, to restrict a large number of computing devices 102-1, 102-2, 102-3, . . . 102-n to be used for hosting the application, any one of the computing devices 102-1, 102-2, 102-3, . . . or 102-n which may be a OSServer 1 maybe selected in the candidate design. In such an implementation, more than one components of the candidate design, the dbServer 4 database server and the WebServer 3, in the present case, reside in a given computing device 102-1, 102-2, 102-3, . . . or 102-n. In other example implementations, however, depending on other considerations such as the amount of load the application is to handle, the candidate design may include two different computing devices, from amongst the computing devices 102-1, 102-2, 102-3, . . . 102-n of the application platform, to support the dbServer 4 and the WebServer 3.

Once a candidate design has been identified, a service design is created and is instantiated to host the application on the application platform based on the candidate design.

The present subject matter allows dependencies for an application to be changed, for example, by modifying the capability attributes and characteristic attributes associated with the application. As and when a change in the capability attributes and characteristic attributes of an application is observed, new candidate designs corresponding to the modified the capability attributes and characteristic attributes may be identified based on the example methods 300 and 400 and new service designs may be created. The process of identification of the candidate designs and generation of new service designs are independent of the skill of the developers to provide various operational requirements for deploying the application and are significantly less time consuming.

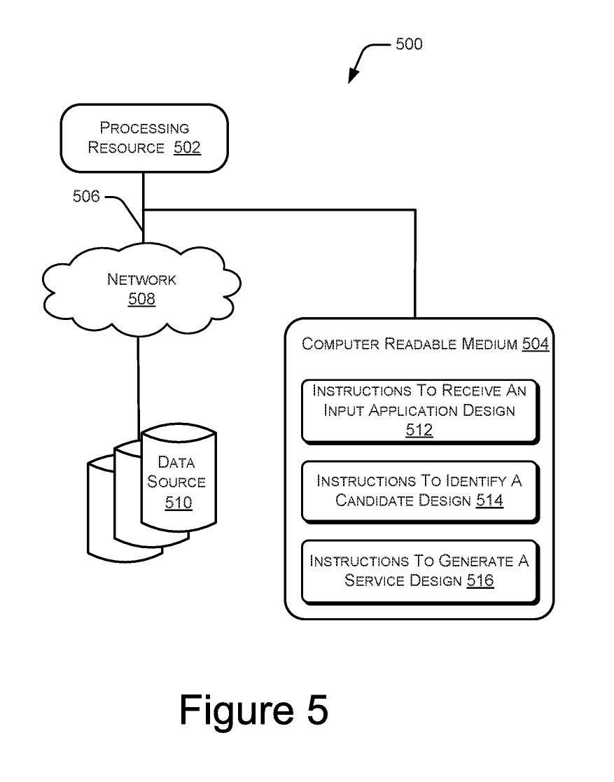

FIG. 5 illustrates an example network environment 500 implementing a non-transitory computer readable medium for deploying applications on application platforms, in accordance with an example of the present subject matter. The network environment 500 may be a public networking environment or a private networking environment. In one implementation, the network environment 500 includes a processing resource 502 communicatively coupled to a non-transitory computer readable medium 504 through a communication link 506.

For example, the processing resource 502 can be a processor of the application deploying system 104. The non-transitory computer readable medium 504 can be, for example, an internal memory device or an external memory device. In one implementation, the communication link 506 may be a direct communication link, such as one formed through a memory read/write interface. In another implementation, the communication link 506 may be an indirect communication link, such as one formed through a network interface. In such a case, the processing resource 502 can access the non-transitory computer readable medium 504 through a network 508. The network 508 may be a single network or a combination of multiple networks and may use a variety of different communication protocols.

The processing resource 502 and the non-transitory computer readable medium 504 may also be communicatively coupled to data sources 510 over the network 508. The data sources 510 can include, for example, computing devices and databases. The data sources 510 may be used by the application deploying system 104 to store data and may serve, for example, as the repository 110 of designs. In one implementation, the non-transitory computer readable medium 504 includes a set of computer readable instructions, such as instructions for implementing the requirement identification module 204, design identification module 206 and service design generation module 208. The set of computer readable instructions, referred to as instructions hereinafter, can be accessed by the processing resource 502 through the communication link 506 and subsequently executed to perform acts for deployment of an application on an application platform.

For discussion purposes, the execution of the instructions by the processing resource 502 has been described with reference to various components introduced earlier with reference to description of FIGS. 1, 2A and 2B.

In an example, instructions 512 can cause the processing resource 502 to receive an input application design for an application. The input application design defines dependencies for the application for one or more application platform based on the capability and the characteristic attribute of the application. Based on the dependencies, components of the application platform for supporting the application may be determined.

Further, based on instructions 514 the processing resource 502 may identify a candidate design to deploy the application. From amongst the numerous designs of the application platform, eligible designs that comprise components to meet the capability attribute and the characteristic attribute of the application are identified. The instructions 514 may further cause the processing resource 502 to examine each of the components of a eligible design to ascertain if the components of the eligible design have any additional deployment requirement. The processing resource 502 may thereafter ascertain if the deployment requirement of the eligible design is fulfilled by the application platform. If the deployment requirement of the eligible design is fulfilled then eligible design is identified as the candidate design by the processing resource 502.

Instructions 516 can cause the processing resource 502 to generate a service design specifying operational requirements to implement the identified candidate design for deploying the application. The service design satisfies all the deployment requirements of the application by taking into consideration the additional deployment requirements the components of the candidate design, if any.

Thus, the methods and systems of the present subject matter provide for deployment of application on the application platform thus increasing efficiency of a developer to design an application independently without having to be aware of the intricate details of the various application platforms.

The methods and systems of the present subject matter provide for deploying an application on an application platform. Although implementations for the network environment 100 and the application deployment system 104 have been described in language specific to structural features and/or methods, it is to be understood that the appended claims are not necessarily limited to the specific features or methods described. Rather, the specific features and methods are disclosed as example implementations for deploying applications on application platforms.

I/We claim:

1. A method for deploying applications on application platforms, the method comprising:
receiving an input application design of an application, wherein the input application design defines dependencies for the application for components of an application platform based on capability attributes and characteristic attributes corresponding to the application, the capability attributes providing deployment requirements of the application and the characteristic attributes providing specifications of the capability attributes corresponding to the components of the application platform;
identifying, based on the capability attributes and characteristic attributes, at least one candidate design comprising at least one of the components of the application platform, the at least one candidate design being a configuration of the application platform to deploy the application; and
based on the at least one candidate design, generating a service design specifying operational requirements for deploying the application on the application platform.

2. The method as claimed in claim 1, wherein identifying the at least one candidate design comprises:
examining components of each of a plurality of designs of the application platform to identify eligible designs having components which conform with the deployment requirements of the application;
ascertaining deployment requirements of the components of the each of the eligible designs; and
identifying an eligible design as a candidate design when the deployment requirements of the components of the eligible design are satisfied by one or more components of the application platform.

3. The method as claimed in claim 1, further comprising:
causing a presentation of a preview of each of the at least one candidate design to a user;
receiving a selection of a candidate design, from amongst the presented at least one candidate design, to generate the service design; and
deploying the application in accordance with the service design.

4. The method as claimed in claim 3, wherein each of the at least one candidate design is presented in one of an interactive mode and a non-interactive mode, such that in the interactive mode, a candidate design to generate the service design is selected by the user and in the non-interactive mode, the candidate design to generate the service design is selected based on predefined rules.

5. The method as claimed in claim 4, wherein in the non-interactive mode, the candidate design to generate the service design is selected automatically based on a preference rating associated with each of the at least one candidate design.

6. The method as claimed in claim 1, wherein identifying the at least one candidate design is based on role-based access rules associated with a user deploying the application.

7. The method as claimed in claim 1 further comprising:
creating a checksum for the service design based on a unique identifier associated with the service design;
comparing the checksum of the service design with a checksum of another application to be deployed, the checksum of the another application being based on a unique identifier associated with the another application and revision and version of application components of the another application; and
reusing the service design for deploying the another application based on the comparison.

8. A system for deploying applications on application platforms, the system comprising:
a processor;
a requirement identification module, coupled to the processor to:
receive an input application design of an application, the input application design defining dependencies for the application for components of an application platform based on a capability attribute that represent a deployment requirement of the application and characteristic attribute that provides a specification of the capability attribute corresponding to the components of the application platform;
a design identification module, coupled to the processor to:
identify, based on the capability attribute and characteristic attribute, at least one candidate design of the application platform to deploy the application, wherein the components of the application platform satisfy deployment requirements for implementing the candidate design; and
a service design generation module, coupled to the processor to:
create a service design based on the at least one candidate design, wherein the service design provides operational requirements to implement the at least one candidate design for deploying the application.

9. The system as claimed in claim 8 further comprising a deployment module, coupled to the processor to deploy the application in accordance with the service design.

10. The system as claimed in claim 8, wherein the requirement identification module is to receive a change in the characteristic attributes and wherein the design identification module is to identify the at least one candidate design based on the change in the characteristic attributes.

11. The system as claimed in claim 8, wherein to identify the at least one candidate design, the design identification module is to:
retrieve a plurality of designs of the application platform from a repository;
examine components of each of the plurality of designs to identify eligible designs having components to fulfill the deployment requirements of the application;
identify deployment requirements of the components of the each of the eligible designs; and
designate an eligible design as a candidate design upon identifying the deployment requirements of the components of the eligible design to be satisfied by one or more components of the application platform.

12. The system as claimed in claim 11, wherein the design identification module is to retrieve the plurality of designs of the application platform based on role-based access rules associated with a user deploying the application.

13. The system as claimed in claim 8 further comprising a service design reuse module, coupled to the processor to:
generate a checksum of an application to be deployed based on a unique identifier associated with the application and revision and version of application components of the application;
generate a checksum of the service design based on a unique identifier associated with the service design;
compare the checksum of the service design with the checksum of application; and
reuse the service design for deploying the application based on the comparison.

14. A non-transitory computer-readable medium comprising instructions for deploying applications on application platforms, executable by a processing resource to:
receive an input application design of an application, the input application design defining dependencies for the application for components of an application platform based on capability attributes that indicate deployment requirements of the application and characteristic attributes that provide specifications corresponding to the deployment requirements;
identify, based on the capability attributes and characteristic attributes of the application, at least one candidate design of the application platform, wherein to deploy the application on the least one candidate design additional deployment requirements of the at least one candidate design are satisfied by the application platform; and
generate a service design based on the at least one candidate design, the service design comprising operational requirements for deploying the application on the application platform.

15. The non-transitory computer-readable medium as claimed in claim 14 further comprising instructions executable to:
examine components of each of a plurality of designs of the application platform to identify eligible designs having components which conform with the deployment requirements of the application;
ascertain deployment requirements of the components of the each of the eligible designs; and
identify an eligible design as a candidate design when the deployment requirements of the components of the eligible design are satisfied by one or more components of the application platform.
